(19) United States
(12) Patent Application Publication
(10) Pub. No.: US 2004/0092247 A1
(43) Pub. Date: May 13, 2004

(54) Portable telephone, auto dial lock method employed therefor and program of the method

(75) Inventor: Yukiko Tani, Saitama (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/671,793

(22) Filed: Sep. 29, 2003

(30) Foreign Application Priority Data
Oct. 2, 2002 (JP) 289329/2002
Apr. 23, 2003 (JP) 117738/2003
Aug. 6, 2003 (JP) 287264/2003

(51) Int. Cl. H04M 1/66; H04M 1/68; H04M 3/16

(52) U.S. Cl. 455/410

(57) ABSTRACT

A foldable type portable telephone capable of making a dial lock function effective with simple operations is provided. In the case where auto dial lock is set, when a control unit of the foldable type portable telephone determines that the telephone is in a wait state and furthermore when an opened state of an upper case and a lower case is detected by a case open/close detection mechanism, the control unit executes activation processing of an auto dial lock unit. When a timer detects that a setting time entered in auto dial lock setting has elapsed, the control unit controls the auto dial lock unit so that it activates dial lock processing for invalidating key entries except at least an entry of personal identification codes used for unlocking in the key operation unit. After this processing, the key operation unit in the foldable type portable telephone accepts only the key entry of personal identification codes.

### BACKGROUND OF THE INVENTION

1. Field of the Invention

The present invention relates to a portable telephone, an auto dial lock method employed therefor and a program of the method, and more particularly to a dial lock method for invalidating key entries in the portable telephone.

2. Description of the Prior Art

Portable telephones conventionally have a dial lock function for invalidating key entries except an entry of personal identification codes used for unlocking or the like, in order to prevent unauthorized use by a third person in case such portable telephones are missing because of being stolen or left behind, or to prevent unintentional wrong key entries when carrying the portable telephone into a bag and the like (e.g., see Non-Patent Document 1).

In this type of portable telephone, by pressing a preset combination of keys or by selecting a dial lock function item on an operation menu or setting menu, the dial lock function becomes effective and key entries except an entry of personal identification codes used for unlocking becomes invalid immediately.

<Non-Patent Document 1>“Dial Lock to Prevent Wrong Operation” (NTT Docomo(R), Mover N504i Operation Manual, Basics, P. 20, Apr., 2002)

The above-mentioned conventional portable telephones come with the dial lock function for preventing unauthorized use when they are missing or for preventing operation mistakes made when being stored somewhere. They force users to remember a combination of keys for making the function effective or to find the dial lock function item from the operation menu or setting menu every time of setting the function.

Therefore, due to the nuisance of such a setting operation, there are not many users who attempt to utilize the dial lock function by conducting the burdensome operation even if they recognize that their own portable telephones have the dial lock function.

The present invention was proposed to address the foregoing problem and an object thereof resides in providing a portable telephone of which a dial lock function may be made effective by simple operations, an auto dial lock method employed for the portable telephone, and a program of the method.

### SUMMARY OF THE INVENTION

A portable telephone according to the first aspect of the present invention is a portable telephone having a first case including a key operation unit, and a second case connected to the first case, wherein when a preset setting time has elapsed since a detection of a state that the first and second cases overlap each other while a terminal of the portable telephone is in a wait state for incoming and outgoing calls, key entries except at least an entry of personal identification codes for unlocking are invalidated in the key operation unit.

A portable telephone according to the second aspect of the present invention is a portable telephone having a first case including a key operation unit, and a second case connected to the first case, wherein the portable telephone comprises determination means for determining whether a terminal of the portable telephone is in a wait state for incoming and outgoing calls; detection means for detecting a state that the first case and the second case overlap each other and a release of the state that the first case and the second case overlap each other; time counting means for counting a preset setting time upon a detection by the detection means of the state that the first and second cases overlap each other; and means for, when the determination means determines to be in the wait state and then the time counting means detects that the setting time has elapsed, invalidating key entries except at least an entry of personal identification codes in the key operation unit.

A portable telephone according to the third aspect of the present invention is a foldable type portable telephone having a first case including a key operation unit, and a second case connected to the first case in a freely openable and closable manner, wherein the foldable type portable telephone comprises determination means for determining whether a terminal of the foldable type portable telephone is in a wait state for incoming and outgoing calls; detection means for detecting an opened state and a closed state of the first and second cases; time counting means for counting a preset setting time upon a detection by the detection means of the closed state of the first and second cases; and means for, when the determination means determines to be in the wait state and then the time counting means detects that the setting time has elapsed, invalidating key entries except at least an entry of personal identification codes in the key operation unit.

A portable telephone according to the fourth aspect of the present invention is a portable telephone having a first case including a key operation unit, and a second case connected to the first case, wherein when a preset setting time has elapsed since a detection of a specified state of the first and second cases while a terminal of the portable telephone is in a wait state for incoming and outgoing calls, key entries except at least an entry of personal identification codes for unlocking are invalidated in the key operation unit.

A portable telephone according to the fifth aspect of the present invention is a portable telephone having a first case including a key operation unit, and a second case connected to the first case, wherein the portable telephone comprises determination means for determining whether a terminal of the portable telephone is in a wait state for incoming and outgoing calls; detection means for detecting a specified state of the first and second cases; time counting means for counting a preset setting time upon a detection by the detection means of the specified state of the first and second cases; and means for, when the determination means determines to be in the wait state and then the time counting means detects that the setting time has elapsed, invalidating key entries except at least an entry of personal identification codes in the key operation unit.

A portable telephone according to the sixth aspect of the present invention is a foldable type portable telephone having a first case including a key operation unit, and a second case connected to the first case in a freely openable and closable manner, wherein when a preset setting time has elapsed since a detection of a specified state of the first and second cases while a terminal of the foldable type portable telephone is in a wait state for incoming and outgoing calls, key entries except at least an entry of personal identification codes for unlocking are invalidated in the key operation unit.

A portable telephone according to the seventh aspect of the present invention is a foldable type portable telephone having a first case including a key operation unit, and a second case connected to the first case in a freely openable and closable manner, wherein the foldable type portable telephone comprises determination means for determining whether a terminal of the foldable type portable telephone is in a wait state for incoming and outgoing calls; detection means for detecting an opened state and a closed state of the first and second cases; time counting means for counting a preset setting time upon a detection by the detection means of a specified state of the first and second cases; and means for, when the determination means determines to be in the wait state and then the time counting means detects that the setting time has elapsed, invalidating key entries except at least an entry of personal identification codes in the key operation unit.

An auto dial lock method according to the first aspect of the present invention is an auto dial lock method for a portable telephone having a first case including a key operation unit, and a second case connected to the first case, wherein the method comprises a first step of determining whether a terminal of the portable telephone is in a wait state for incoming and outgoing calls; a second step of detecting a state that the first and second cases overlap each other and a release of the state that the first and second cases overlap each other; a third step of determining whether a preset setting time has elapsed since the detection of the state that the first and second cases overlap each other; and a fourth step of, when determined to be in the wait state and then detected that the setting time has elapsed, invalidating key entries except at least an entry of personal identification codes in the key operation unit.

An auto dial lock method according to the second aspect of the present invention is an auto dial lock method for a portable telephone having a first case including a key operation unit, and a second case connected to the first case, wherein the method comprises a first step of determining whether a terminal of the portable telephone is in a wait state for incoming and outgoing calls; a second step of detecting a specified state of the first and second cases; a third step of determining whether a preset setting time has elapsed since the detection of the specified state; and a fourth step of, when determined to be in the wait state and then detected that the setting time has elapsed, invalidating key entries except at least an entry of personal identification codes in the key operation unit.

An auto dial lock method according to the third aspect of the present invention is an auto dial lock method for a foldable type potable telephone having a first case including a key operation unit, and a second case connected to the first case in a freely openable and closable manner, wherein the method comprises a step of determining whether a terminal of the foldable type portable telephone is in await state for incoming and outgoing calls; a step of detecting an opened state and a closed state of the first and second cases; a step of determining whether a preset setting time has elapsed since the detection of the closed state of the first and second cases; and a step of, when determined to be in the wait state and then detected that the setting time has elapsed, invalidating key entries except at least an entry of personal identification codes in the key operation unit.

An auto dial lock method according to the fourth aspect of the present invention is an auto dial lock method for a foldable type potable telephone having a first case including a key operation unit, and a second case connected to the first case in a freely openable and closable manner, wherein the method comprises a step of determining whether a terminal of the foldable type portable telephone is in await state for incoming and outgoing calls; a step of detecting a specified state of the first and second cases; a step of determining whether a preset setting time has elapsed since the detection of the specified state; and a step of, when determined to be in the wait state and then detected that the setting time has elapsed, invalidating key entries except at least an entry of personal identification codes in the key operation unit.

A program for an auto dial lock method according to the first aspect of the present invention is a program of an auto dial lock method for a portable telephone having a first case including a key operation unit, and a second case connected to the first case, wherein the program makes a computer execute the steps of determining whether a terminal of the portable telephone is in a wait state for incoming and outgoing calls; detecting a state that the first and second cases overlap each other and a release of the state that the first and second cases overlap each other; determining whether a preset setting time has elapsed since the detection of the state that the first and second cases overlap each other; and when determined to be in the wait state and then detected that the setting time has elapsed, invalidating key entries except at least an entry of personal identification-codes in the key operation unit.

A program of an auto dial lock method according to the second aspect of the present invention is a program of an auto dial lock method for a foldable type portable telephone having a first case including a key operation unit, and a second case connected to the first case, wherein the program makes a computer execute the steps of determining whether a terminal of the portable telephone is in a wait state for incoming and outgoing calls; detecting a specified state of the first and second cases; determining whether a preset setting time has elapsed since the detection of the specified state; and when determined to be in the wait state and then detected that the setting time has elapsed, invalidating key entries except at least an entry of personal identification codes in the key operation unit.

A program of an auto dial lock method according to the third aspect of the present invention is a program of an auto dial lock method for a foldable type portable telephone having a first case including a key operation unit, and a second case connected to the first case in a freely openable and closable manner, wherein the program makes a computer execute the steps of determining whether a terminal of the foldable type portable telephone is in a wait state for incoming and outgoing calls; detecting an opened state and a closed state of the first and second cases; determining whether a preset setting time has elapsed since the detection of the closed state of the first and second cases; and when determined to be in the wait state and then detected that the setting time has elapsed, invalidating key entries except at least an entry of personal identification codes in the key operation unit.

A program of an auto dial lock method according to the fourth aspect of the present invention is a program of an auto dial lock method for a foldable type portable telephone having a first case including a key operation unit, and a second case connected to the first case in a freely openable and closable manner, wherein the program makes a computer execute the steps of determining whether a terminal of the foldable type portable telephone is in a wait state for incoming and outgoing calls; detecting a specified state of the first and second cases; determining whether a preset setting time has elapsed since the detection of the specified state of the first and second cases; and when determined to be in the wait state and then detected that the setting time has elapsed, invalidating key entries except at least an entry of personal identification codes in the key operation unit.

That is, the portable telephone of the present invention in which an upper case equipped with a display unit and a lower case equipped with a key operation unit are connected with each other, executes dial lock for invalidating key entries except at least an entry of personal identification codes used for unlocking in the key operation unit, when a preset setting time has elapsed since the upper and lower cases overlapped each other while a terminal of the portable telephone is in a wait state for incoming and outgoing calls. Therefore, with the portable telephone of the present invention, once the auto dial lock is set which is automatically activated in response to an operation for bringing the upper and lower cases into an overlapping state and a release operation of the overlapping state, the dial lock is automatically activated to the key operation unit, thus eliminating the need for users to perform burdensome setting operations each time needed and allowing them to make the dial lock function effective with simple operations.

The operation for bringing the upper and lower cases into the overlapping state and the release operation of the state correspond to, in the case of a foldable type portable telephone in which the upper and lower cases are connected with each other in a freely openable and closable manner using a hinge and the like, opening and closing operations of the both cases, and correspond to, in the case of a rotary type portable telephone in which the upper cases is connected to the lower case via a joining part so as to be rotated along a key operation face of the key operation unit, a rotary operation of the both cases, and further correspond to, in the case of a slide storage type portable telephone in which the upper case freely receives the lower case by sliding it in a longitudinal direction, a sliding operation of the both cases.

Moreover, with the portable telephone of the present invention, when a previously set predetermined operation is performed before the setting time elapses, the elapse of the setting time is once cleared and then recounted. Therefore, once the auto dial lock is set, the dial lock is automatically activated to the key operation unit even when the predetermined operation is performed in the course of the count of the setting time, thus eliminating the need for users to perform burdensome setting operations each time needed and allowing them to make the dial lock function effective with simple operations.

According to the present invention, in a portable telephone which has a first case including a key operation unit and has a second case connected to the first case, the dial lock is activated to invalidate key entries except at least an entry of personal identification codes used for unlocking in the key operation unit, when a preset setting time has elapsed since the detection of the state that the first and second cases overlap each other and a release of the state while a terminal of the portable telephone is in a wait state for incoming and outgoing calls, thereby providing an advantage of making a dial lock function effective with simple operations.

### BRIEF DESCRIPTION OF THE DRAWINGS

FIG. 1 is a block diagram showing a configuration of a foldable type portable telephone according to a first embodiment of the present invention;

FIGS. 2A to 2D are diagrams showing one example of an auto dial lock setting procedure for the foldable type portable telephone according to the first embodiment of the present invention;

FIG. 3 is a flowchart exemplarily showing an auto dial lock process of the foldable type portable telephone according to the first embodiment of the present invention;

FIG. 4 is a flowchart exemplarily showing an auto dial lock process of the foldable type portable telephone according to a second embodiment of the present invention;

FIG. 5 is a block diagram showing a configuration of the foldable type portable telephone according to a third embodiment of the present invention;

FIG. 6 is a flowchart exemplarily showing an auto dial lock setting procedure for the foldable type portable telephone according to a fourth embodiment of the present invention;

FIGS. 7A to 7C are diagrams showing operations during time in use of a rotary type portable telephone according to a fifth embodiment of the present invention;

FIG. 8 is a block diagram showing a configuration of the rotary type portable telephone according to the fifth embodiment of the present invention;

FIGS. 9A and 9B are diagrams showing operations during time in use of a slide storage type portable telephone according to a sixth embodiment of the present invention;

FIGS. 10A and 10B are diagrams showing operations during time in use of the slide storage type portable telephone according to the sixth embodiment of the present invention; and

FIG. 11 is a block diagram showing a configuration of the slide storage type portable telephone according to the sixth embodiment of the present invention.

### DETAILED DESCRIPTION OF THE PREFERRED EMBODIMENTS

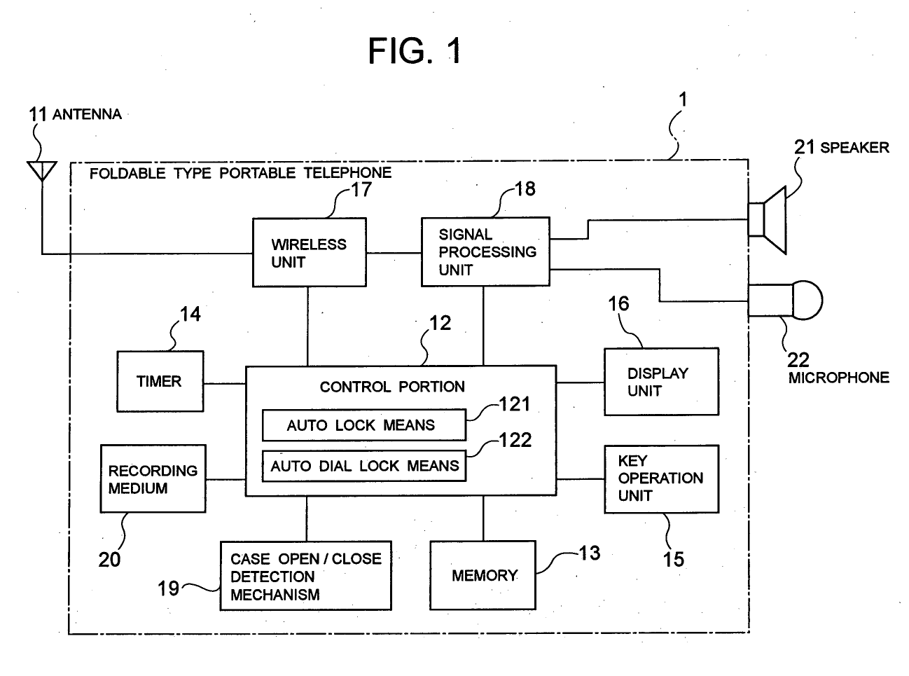

Embodiments of the present invention will be described with reference to the drawings. FIG. 1 is a block diagram showing a configuration of a foldable type portable telephone according to a first embodiment of the present invention. It will be observed from FIG. 1 that a foldable type portable telephone 1 is configured with an antenna 11, a control unit 12, a memory 13, a timer 14, a key operation unit 15, a display unit 16, a wireless unit 17, a signal processing unit 18, a case open/close detection mechanism 19, a recording medium 20, a speaker 21, and a microphone 22, and has an upper case (not shown) equipped with the display unit 16 and a lower case (not shown) equipped with the key operation unit 15 which are connected with each other in a freely openable and closable manner by using a hinge and the like.

The antenna 11 is operable to transmit and receive radio waves, the key operation unit 15 is operable for a user to perform operations for various settings and personal identification codes, or operations for incoming and outgoing calls, and the display unit 16 is operable to display operation menus when the user performs the operations for various settings and personal identification codes, or operations for incoming and outgoing calls. The wireless unit 17 is operable to execute wireless-related processing, and the signal processing unit 18 is operable to process receiving and transmitting signals. The speaker 21 is operable to output received sounds, and the microphone 22 is operable to receive sound inputs.

The control unit 12 is connected to and controls each of the memory 13, the timer 14, the key operation unit 15, the display unit 16, the wireless unit 17, and the signal processing unit 18. In addition, the control unit 12 includes dial lock means 121 for activating, to the key operation unit 15, dial lock for invalidating key entries except an entry of the personal identification codes or the like, and auto dial lock means 122 for automatically activating the dial lock (hereinafter referred to as auto dial lock) to the key operation unit 15 in response to opening and closing operations of the upper and lower cases.

The opening and closing operations of the upper and lower cases are detected by the case open/close detection mechanism 19. This detection is effected by using techniques of detecting such opening operation and closing operations of the upper and lower cases with the aid of, for example, a magnet or an ON/OFF type microswitch.

The memory 13 stores various setting information, personal identification codes, and the like. The timer 14, when activated by the control unit 12, starts counting the elapse of time and notifies the control unit 12 that the time is up when a specified time has elapsed. The recording medium 20 stores a program (a computer-executable program) for realizing processing in each of the above units, so that the control unit 12 may control the above units by executing the program stored in the recording medium 20.

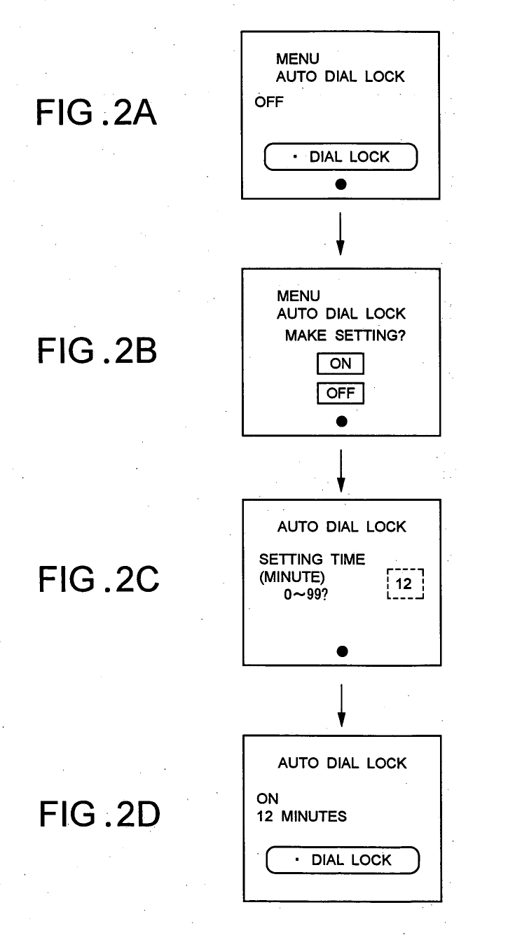

FIGS. 2A to 2D are diagrams showing one example of an auto dial lock setting procedure for the foldable type portable telephone 1 according to the first embodiment of the present invention. Referring to these drawings, the description will be made for the auto dial lock setting procedure for the foldable type portable telephone 1.

First, when the auto dial lock of the foldable type portable telephone 1 is set, the auto dial lock is selected on a menu screen of the display unit 16 (see FIG. 2A), and is then set on a setting screen of the display unit 16 (see FIG. 2B).

In this case, when a setting time N (N is 12 minutes in the example shown on the drawing) is specified on the setting screen where the setting time until the activation of the auto dial lock is to be entered (see FIG. 2C), the display unit 16 displays that the auto dial lock is initiated after 12 minutes (see FIG. 2D). In FIG. 2C, the setting time N is selected from 0 to 99 minutes, however, this is merely one example and the setting time N may alternatively be longer than 99 minutes. If the setting time N is set to 0 minute, the auto dial lock is activated immediately after the case open/close detection mechanism 19 detects a closed state of the upper and lower cases.

Subsequently, the foldable type portable telephone 1 goes into a wait state for incoming and outgoing calls, that is, an incoming and outgoing call waiting state other than a halfway state of some sort of operations or an input-wait state for such operations. When the case open/close detection mechanism 19 detects the closed state of the upper and lower cases and the timer 14 then notifies the control unit 12 that the setting time has elapsed, the auto dial lock means 122 executes the auto dial lock.

On the other hand, when personal identification codes used for unlocking are entered from the key operation unit 15, the auto dial lock being executed by the auto dial lock means 122 is released. The foldable type portable telephone 1 again goes into the wait state, and when the setting time has elapsed after the detection of the upper and lower case closed state by the case open/close detection mechanism 19, the auto dial lock is executed without the need of newly setting the same.

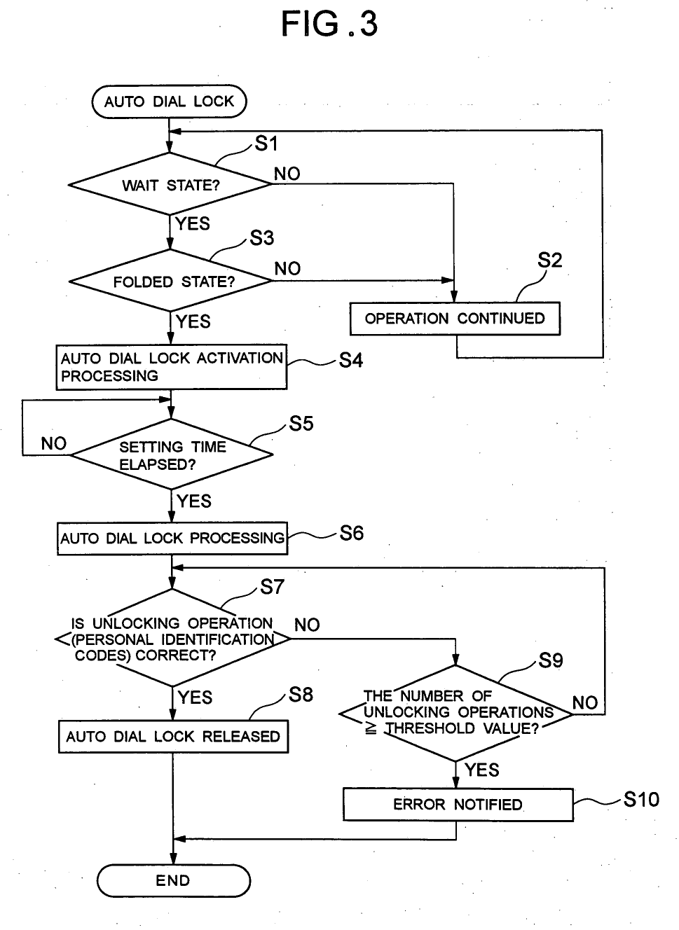

FIG. 3 is a flowchart exemplarily showing an auto dial lock process of the foldable type portable telephone 1 according to the first embodiment of the present invention! Referring to FIGS. 1 to 3, next paragraphs will deal with the auto dial lock process of the foldable type portable telephone 1 according to the first embodiment of the-present invention.

When the auto dial lock is set, the control unit 12 in the foldable type portable telephone 1 determines whether the telephone 1 is in the wait state for incoming and outgoing calls on the basis of each operation state of the key operation unit 15, the display unit 16, the wireless unit 17, and the signal processing unit 18 (Step S1 in FIG. 3). When determining that the telephone 1 is in anon-wait state, the control unit 12 continues each unit on operations thereof (Step S2 in FIG. 3). It is to be noted here that the “non-wait state” may conceivably include states during telephone conversation, during creation of a transmission mail, during perusal of a received mail, during Internet surfing, during confirmation/setting of various setting items, during composition of a ringer melody, or the like.

When determining that the telephone 1 is in the wait state, the control unit 12 continues each unit on operations thereof (step S2 in FIG. 3) if the opened state of the upper and lower cases is detected by the case open/close detection mechanism 19 (step S3 in FIG. 3). If the closed state is detected by the case open/close detection mechanism 19 (step S3 in FIG. 3), the control unit 12 executes activation processing of the auto dial lock means 122 (step S4 in FIG. 3).

When the setting time entered at the time of setting the auto dial lock has elapsed (step S5 in FIG. 3), the control unit 12 controls the auto dial lock means 122 so that it activates the auto dial lock processing for the key operation unit 15 (step S6 in FIG. 3). After this processing, the key operation unit 15 in the foldable type portable telephone 1 accepts only a key entry of personal identification codes for unlocking.

In the foldable type portable telephone 1, when the personal identification codes used for unlocking are entered from the key operation unit 15 and the codes agree with those previously set (when the personal identification codes are correct) (step S7 in FIG. 3), the control unit 12 releases the auto dial lock of the auto dial lock means 122 (step S8 in FIG. 3).

When the personal identification codes used for unlocking which are entered from the key operation unit 15 do not agree with those previously set (when the personal identification codes are incorrect) (step S7 in FIG. 3) and furthermore, when the number of the unlocking operations is below a preset threshold value (step S9 in FIG. 3), the control unit 12 returns the process to step S7. Contrary to this when the number of the unlocking operations reaches or exceeds the threshold value (step S9 in FIG. 3), the control unit 12 notifies users of an error and turns a battery off to maintain the state that the auto dial lock is still effective (step S10 in FIG. 3).

In this embodiment, as described above, once the auto dial lock is set, it is automatically activated to the key operation unit 15 when the setting time has elapsed since the detection of the closed state of the upper and lower cases while the foldable type portable telephone 1 is in the wait state, thus eliminating the need for users to perform burdensome setting operations each time needed and allowing them to make the dial lock function effective with simple operations.

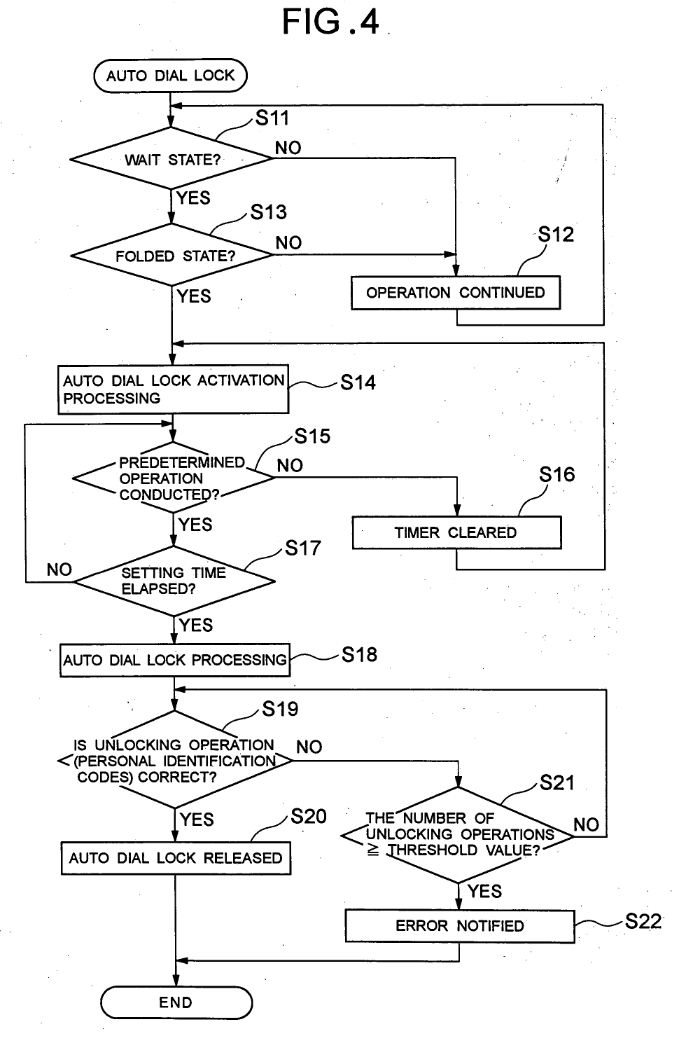

FIG. 4 is a flowchart exemplarily showing an auto dial lock process of the foldable type portable telephone according to a second embodiment of the present invention. Since the foldable type portable telephone according to the second embodiment of the present invention has the same configuration as that of the foldable type portable telephone 1 according to the first embodiment shown in FIG. 1, these FIGS. 1 and 4 will be referred to explain the auto dial lock process of the foldable type portable telephone 1 according to the second embodiment of the present invention.

When the auto dial lock is set, the control unit 12 of the foldable type portable telephone 1 determines whether the telephone 1 is in the wait state for incoming and outgoing calls on the basis of each operation state of the key operation unit 15, the display unit 16, the wireless unit 17, and the signal processing unit 18 (step S11 in FIG. 4). When determining that the telephone 1 is in the non-wait state, the control unit 12 continues each unit on operations thereof (step S12 in FIG. 4).

When determining that the telephone 1 is in the wait state, the control unit 12 continues each unit on operations thereof (step S12 in FIG. 4) if the opened state of the upper and lower cases is detected by the case open/close detection mechanism 19 (step S13 in FIG. 4). If the closed state is detected by the case open/close detection mechanism 19 (step S13 in FIG. 4), the control unit 12 executes activation processing of the auto dial lock means 122 (step S14 in FIG. 4).

When a predetermined operation previously set is performed before the setting time entered at the time of setting the auto dial lock elapses (step S15 in FIG. 4), the control unit 12 clears the timer 14 (step 16 in FIG. 4) and returns the process to step S15. It is to be noted here that the predetermined operation includes an operation of shifting the upper and lower cases from the closed state to the opened state, an operation of pressing a side key (not shown) down, an operation of connecting an external connection device to an external connection terminal, or the like. When any of these operations is made, the control unit 12 once clears the timer 14 and returns the process to step S14 so that the timer 14 starts counting again.

When the setting time entered at the time of setting the auto dial lock has elapsed (step S17 in FIG. 4), the control unit 12 controls the auto dial lock means 122 so that it activates the auto dial lock processing for the key operation unit 15 (step S18 in FIG. 4). After this processing, the key operation unit 15 in the foldable type portable telephone 1 accepts only a key entry of personal identification codes for unlocking.

In the foldable type portable telephone 1, when the personal identification codes used for unlocking are entered from the key operation unit 15 and the codes agree with those previously set (when the personal identification codes are correct)(step S19 in FIG. 4), the control unit 12 releases the auto dial lock of the auto dial lock means 122 (step S20 in FIG. 4).

When the personal identification codes used for unlocking which are entered from the key operation unit 15 do not agree with those previously set (when the personal identification codes are incorrect) (step S19 in FIG. 4) and furthermore, when the number of the unlocking operations is below a preset threshold value (step S21 in FIG. 4), the control unit 12 returns the process to step S19. Contrary to this when the number of the unlocking operations reaches or exceeds the threshold value (step S22 in FIG. 4), the control unit 12 notifies users of an error and turns a battery off to maintain the state that the auto dial lock is still effective (step S23 in FIG. 4).

In this embodiment, as described above, once the auto dial lock is set, it is automatically activated to the key operation unit 15 when the setting time has elapsed since the detection of the closed state of the upper and lower cases while the foldable type portable telephone 1 is in the wait state, even if the predetermined operation is performed in the course of counting by the timer 4, thus eliminating the need for users to perform burdensome setting operations each time needed and allowing them to make the dial lock function effective with simple operations.

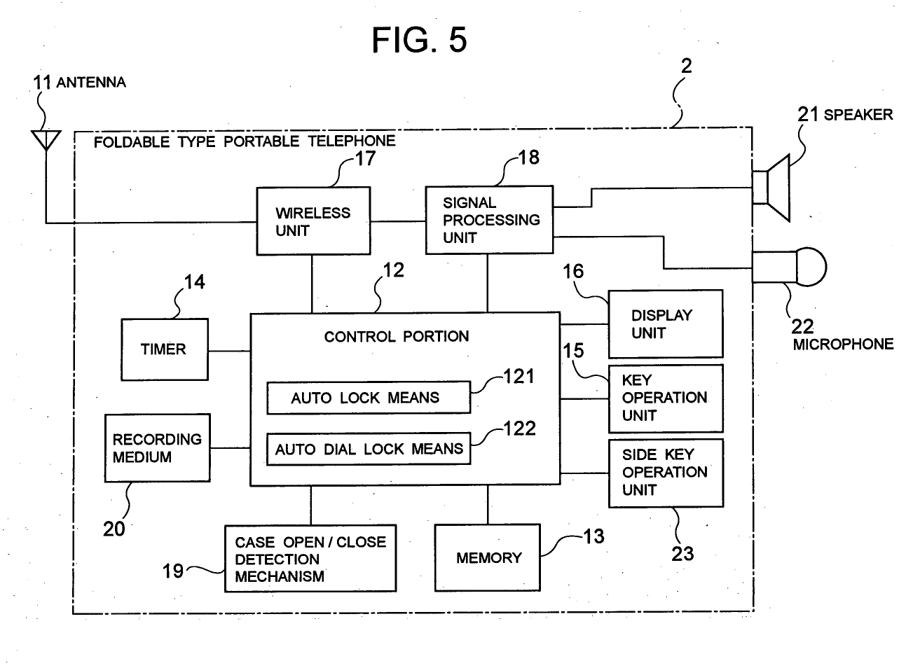

FIG. 5 is a block diagram showing a configuration of a foldable type portable telephone according to a third embodiment of the present invention. It will be observed from FIG. 5 that a foldable type portable telephone 2 according to the third embodiment has the same configuration as that of the foldable type portable telephone 1 according to the first embodiment shown in FIG. 1 except that it is provided with a side key operation unit (side key) 23 in addition to the key operation unit 15, and that the same reference numerals are allocated to the same components. Furthermore, operations of the same components are identical to those in the first embodiment.

The side key operation unit 23 is to be operated during the closed state of the upper and lower cases, and for example, even when the counting of the elapse of time is started for the setting time until the activation of the auto dial lock to the key operation unit 15, a pressing operation onto the side key operation unit 23 may trigger a reset of the counted time and a restart of counting the setting time from 0 second.

Accordingly, in this embodiment, even in the closed state of the upper and lower cases, the setting time elapsing until the auto dial lock is activated may be elongated by the pressing the side key operation unit 23.

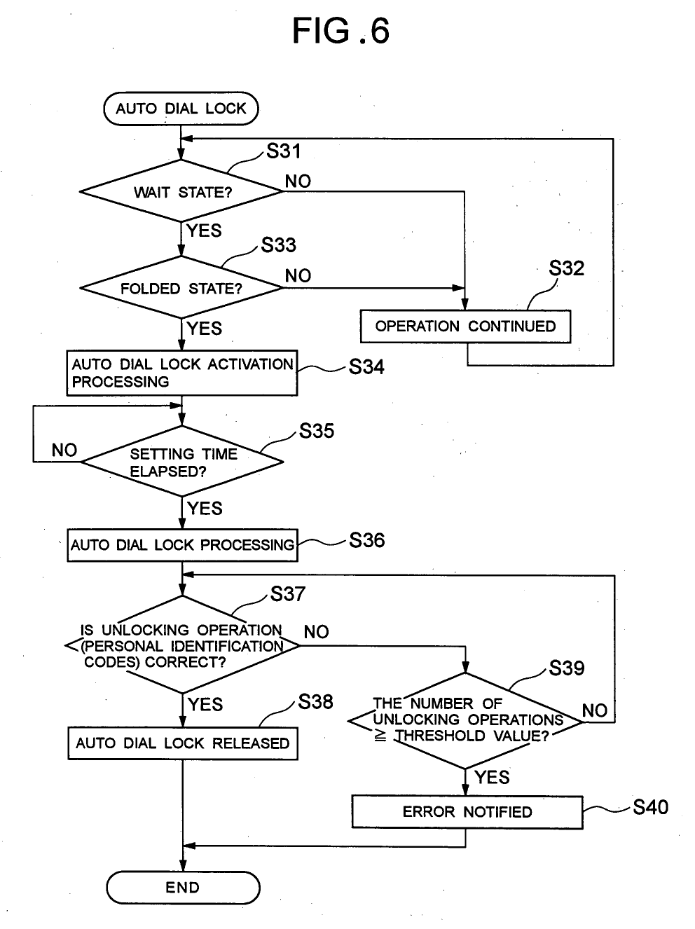

FIG. 6 is a flowchart exemplarily showing an auto dial lock process of the foldable type portable telephone according to a fourth embodiment of the present invention. Since the foldable type portable telephone according to the fourth embodiment has the same configuration as that of the foldable type portable telephone 1 according to the first embodiment shown in FIG. 1, these FIGS. 1 and 6 will be referred to explain the auto dial lock process of the foldable type portable telephone 1 according to the fourth embodiment of the present invention.

When the auto dial lock is set, the control unit 12 of the foldable type portable telephone 1 determines whether the telephone 1 is in the wait state for incoming and outgoing calls on the basis of each operation state of the key operation unit 15, the display unit 16, the wireless unit 17 and the signal processing unit 18 (step S31 in FIG. 6).

When determining that the telephone 1 is in the non-wait state, the control unit 12 continues each unit on operations thereof (step S32 in FIG. 6). It is to be noted here that the “non-wait state” may conceivably include during telephone conversation, during creation of a transmission mail, during perusal of a received mail, during Internet surfing, during confirmation/setting of various setting items, during composition of a ringer melody, or the like.

When determining that the telephone 1 is in the wait state, the control unit 12 continues each unit on operations thereof (step S32 in FIG. 6) if the closed state of the upper and lower cases is detected by the case open/close detection mechanism 19 (step S33 in FIG. 6).

If the opened state is detected by the case open/close detection mechanism 19 (step S33 in FIG. 6), the control unit 12 executes activation processing of the auto dial lock means 122 (step S34 in FIG. 6).

When the setting time entered at the time of setting the auto dial lock has elapsed (step S35 in FIG. 6), the control unit 12 controls the auto dial lock means 122 so that it activates the auto dial lock processing for the key operation unit 15 (step S36 in FIG. 6). After this processing, the key operation unit 15 in the foldable type portable telephone 1 accepts only a key entry of personal identification codes for unlocking.

In the foldable type portable telephone 1, when the personal identification codes used for unlocking are entered from the key operation unit 15 and the codes agree with those previously set (when the personal identification codes are correct)(step S37 in FIG. 6), the control unit 12 releases the auto dial lock of the auto dial lock means 122 (step S38 in FIG. 6).

When the personal identification codes used for unlocking which are entered from the key operation unit 15 do not agree with those previously set (when the personal identification codes are incorrect) (step S37 in FIG. 6) and furthermore, when the number of the unlocking operations is below a preset threshold value (step S39 in FIG. 6), the control unit 12 returns the process to step S37. Contrary to this when the number of the unlocking operations reaches or exceeds the threshold value (step S39 in FIG. 6), the control unit 12 notifies users of an error and turns a battery off to maintain the state that the auto dial lock is still effective (step S40 in FIG. 6).

In this embodiment, as described above, once the auto dial lock is set, it is automatically activated to the key operation unit 15 when the setting time has elapsed since the detection of the opened state of the upper and lower cases while the foldable type portable telephone 1 is in the wait state, which enables the auto dial lock even in the opened state. This eliminates the need for users to perform burdensome setting operations each time needed and allows them to make the dial lock function effective with simple operations.

While the above mentioned first to fourth embodiments dealt with only the foldable type portable telephone in which the upper case and lower case are joined with each other by hinges and the like so as to provide successful opening and closing operations, however, the functional operations described in each of the above embodiments are applicable also to a rotary type portable telephone in which the upper and lower cases are joined with each other by hinges and the like to provide a rotary operation, a slide storage type portable telephone in which the upper and lower cases provide a sliding operation relative to each other, or the like.

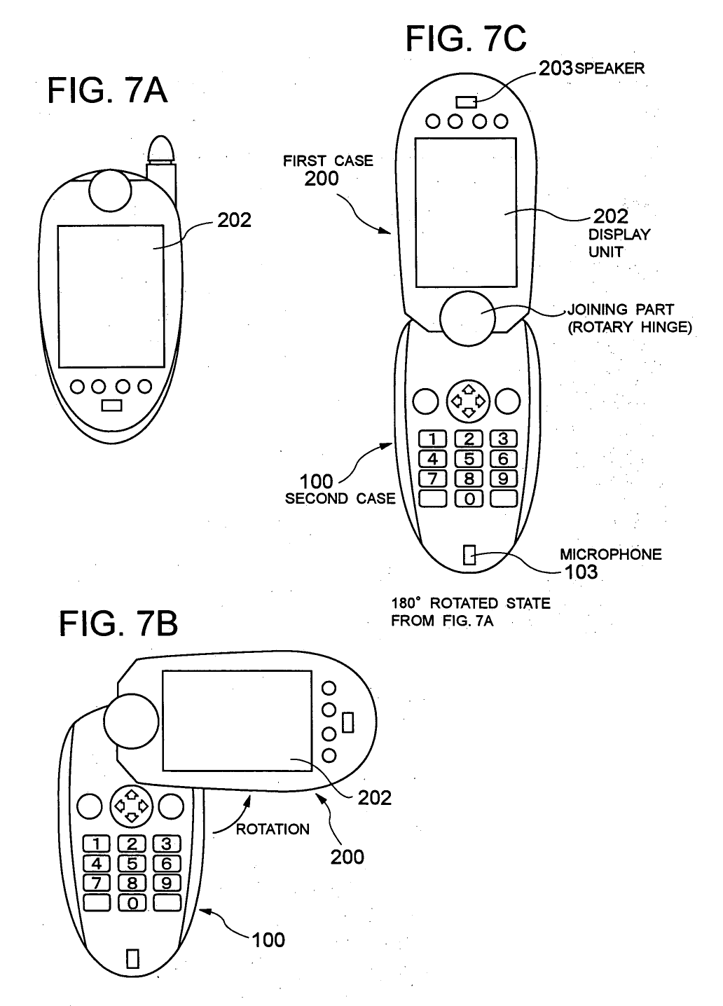

FIGS. 7A to 7C are diagrams showing operations during time in use of the rotary type portable telephone according to a fifth embodiment of the present invention. FIG. 7A shows a state in which a first case 200 and a second case 100 overlap each other in the rotary type portable telephone according to the fifth embodiment of the present invention, FIG. 7B shows a state in which the first case 200 is turned 90° relative to the second case 100, and FIG. 7C shows a state in which the first case 200 is turned another 900 relative to the second case 100, that is, a state in which the first case 200 is turned 180° from the state shown in FIG. 7A.

As shown in FIGS. 7A to 7C, the first case 200 and the second case 100 are rotatably connected with each other via the joining part (rotary hinge) with the first case 200 being provided with a display unit 202 and a speaker 203 and the second case 100 being provided with a microphone 103.

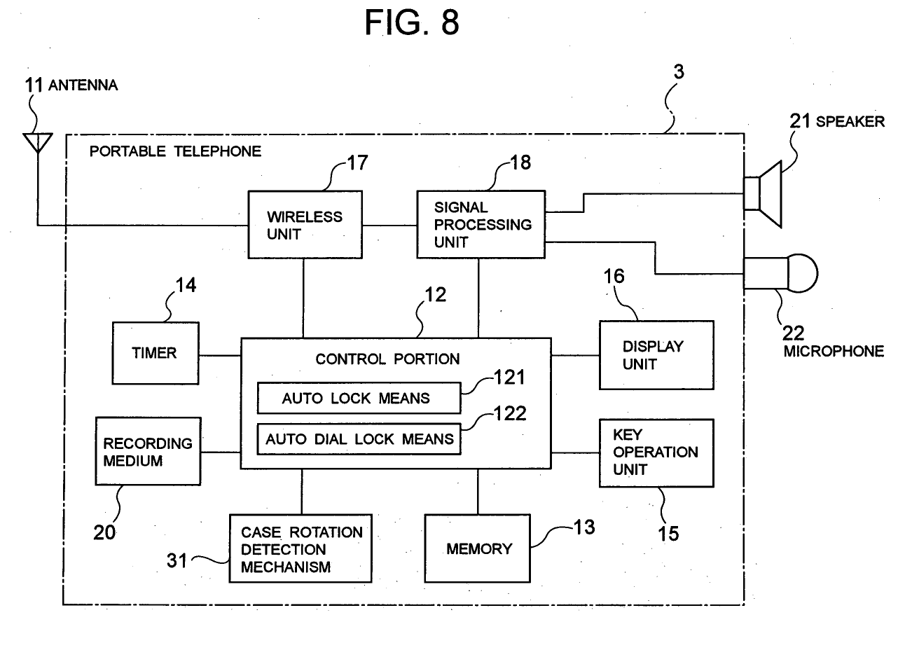

FIG. 8 is a block diagram showing a configuration of the rotary type portable telephone according to the fifth embodiment of the present invention. It will be observed from FIG. 8 that a rotary type portable telephone 3 according to the fifth embodiment has the same configuration as that of the foldable type portable telephone 1 according to the first embodiment shown in FIG. 1 except that it includes a case rotation detection mechanism 31 in place of the case open/close detection mechanism 19, and that the same reference numerals are allocated to the same components. Furthermore, operations of the same components are identical to those in the first embodiment of the present invention.

The case rotation detection mechanism 31 detects a rotary operation of the first case 200 and the second case 100 shown in FIG. 7. The detection of the rotary operation by the case rotation detection mechanism 31 is effected by detecting a position of a pin (not shown) that rotates interlockingly with the rotary operation of the first case 200, whereby it can be detected that which one of positional relationships of FIGS. 7A, 7B and 7C corresponds to a relative position of the first and second cases. Note here that it is possible to use a magnet in order to detect the relative position of the first case 200 and the second case 100.

In the rotary type portable telephone 3 according to the fifth embodiment, an overlapping state of the first case 200 and the second case 100 (see FIG. 7A) is detected by the case rotation detection mechanism 31 and thereafter the timer 14 notifies the control unit 12 that the setting time has elapsed. Upon receipt of the notification, the auto dial lock means 122 executes the auto dial lock.

In this embodiment, as described above, once the auto dial lock is set, it is automatically activated to the key operation unit 15 when the setting time has elapsed since the detection by the case rotation detection mechanism 31 of the overlapping state of the first case 200 and the second case 100 (shown in FIG. 7A) or since the detection of the states shown in FIGS. 7B and 7C while the rotary type portable telephone 3 is in the wait state, thus eliminating the need for users to perform burdensome setting operations each time needed and allowing them to make the dial lock function effective with simple operations.

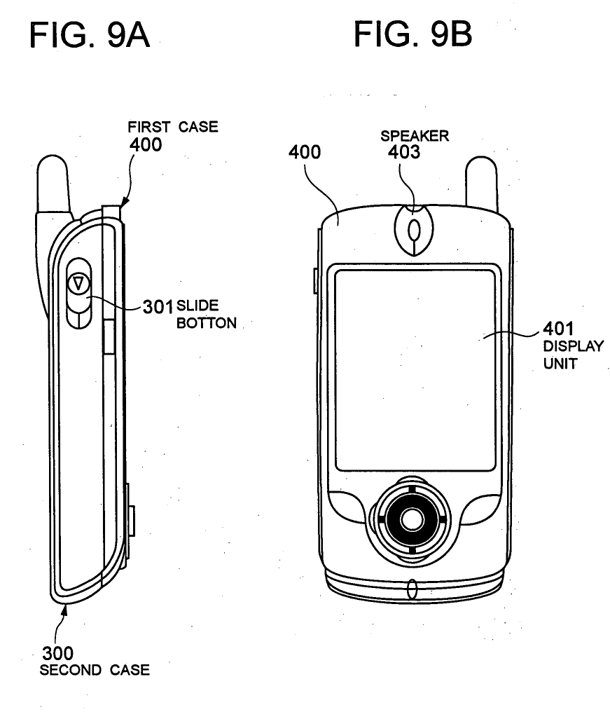

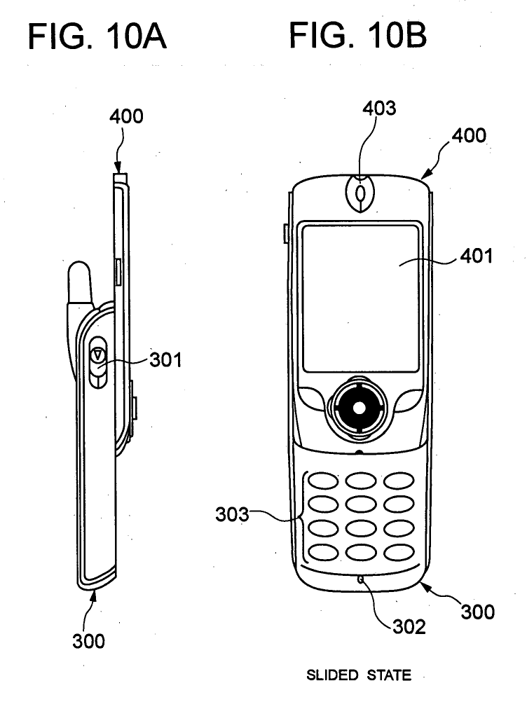

FIGS. 9A to 9B and FIGS. 10A to 10B are diagrams showing operations during time in use of a slide storage type portable telephone according to a sixth embodiment of the present invention.

FIGS. 9A and 9B show a state in which a first case 400 and a second case 300 overlap each other, that is, a state in which the second case 300 is received by the first case 400, and FIGS. 10A and 10B show a state in which the second case 300 is drawn out by sliding it from the first case 400, in the slide storage type portable telephone according to the sixth embodiment of the present invention.

It will be observed from FIGS. 10A and 10B that the first case 400 and the second case 300 are slidably connected to each other by a rail mechanism (not shown) or the like with the first case 400 being provided with a display unit 401 and a speaker 403 and the second case 300 being provided with a slide button 301, a microphone 302 and key arrays 303.

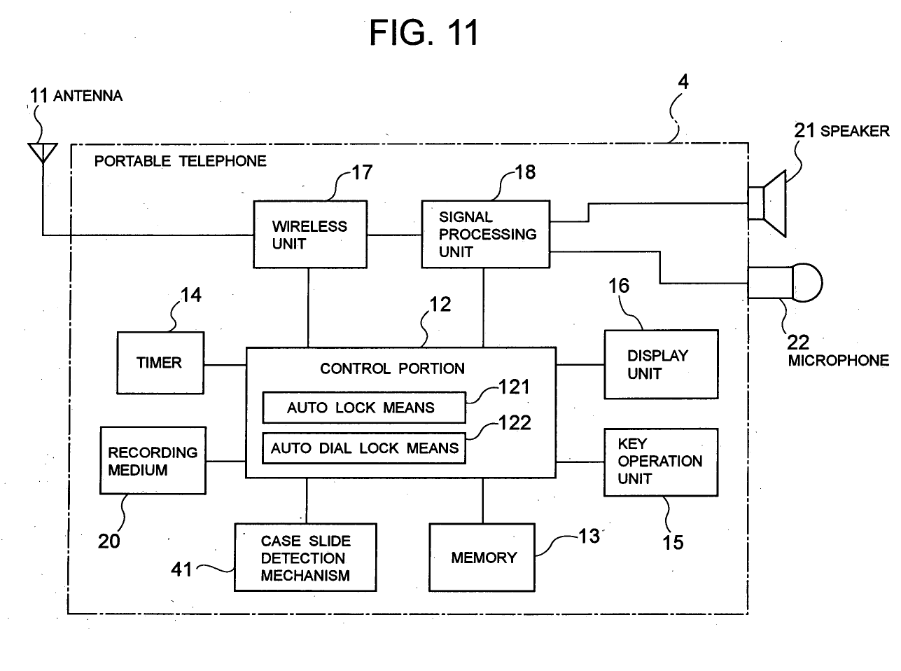

FIG. 11 is a block diagram showing a configuration of the slide storage type portable telephone according to the sixth embodiment of the present invention. As shown in FIG. 11, a slide storage type portable telephone 4 according to the sixth embodiment has the same configuration as that of the foldable type portable telephone 1 according to the first embodiment shown in FIG. 1 except that it is provided with a case slide detection mechanism 41 in place of the case open/close detection mechanism 19, and the same reference numerals are allocated to the same components. Furthermore, operations of the same components are identical to those in the first embodiment.

The case slide detection mechanism 41 detects the sliding operation of the second case 300 with respect to the first case 400 which is shown in FIGS. 9 and 10. The detection of the sliding operation by the case slide detection mechanism 41 is effected by detecting a position of a pin (not shown) that slides interlockingly with the sliding operation of the second case 300, whereby it can be detected that which one of positional relationships of FIGS. 9A and 9B and FIGS. 10A and 10B corresponds to a relative position of the first case 400 and the second case 300. Note here that it is possible to use a magnet in order to detect the relative position of the first case 400 and the second case 300.

In the slide storage type portable telephone 4 according to the sixth embodiment of the present invention, the overlapping state of the first case 400 and the second case 300 (see FIGS. 9A and 9B) is detected by the case slide detection mechanism 41 and thereafter the timer 14 notifies the control unit 12 that the setting time has elapsed. Upon receipt of the notification, the auto dial lock means 122 executes the auto dial lock.

In this embodiment, as described above, once the auto dial lock is set, it is automatically activated to the key operation unit 15 when the setting time has, elapsed since the case slide detection mechanism 41 detected the overlapping state of the first case 400 and the second case 300 (FIGS. 9A and 9B) or the state shown in FIGS. 10A and 10B while the slide storage type portable telephone 4 is in the wait state, thus eliminating the need for users to perform burdensome setting operations each time needed and allowing them to make the dial lock function effective with simple operations.

It is alternatively possible in this invention to combine the aforementioned embodiments one another, and the present invention is not limited to the above embodiments. When the above embodiments are used in combination, the setting from the outside is to be made possible for one or both of the opened state and closed state of the upper case and the lower case, one or both of the overlapping state and a release thereof between the first case. 200 and the second case 100, or one or both of the overlapping state and a release thereof between the first case 400 and the second case 300.

What is claimed is:

1. A portable telephone having a first case including a key operation unit, and a second case connected to said first case, wherein
when a preset setting time has elapsed since a detection of a state that said first and second cases overlap each other while a terminal of the portable telephone is in a wait state for incoming and outgoing calls, key entries except at least an entry of personal identification codes for unlocking are invalidated in said key operation unit.

2. The portable telephone according to claim 1, wherein said second case is a foldable type terminal connected to said first case via a joining part in a freely openable and closable manner.

3. The portable telephone according to claim 1, wherein said second case is a rotary type terminal connected to said first case via a joining part so as to be rotated along a key operation face of said key operation unit.

4. The portable telephone according to claim 1, wherein said second case is a slide storage type terminal that freely receives said first case by sliding the first case in a longitudinal direction.

5. A portable telephone having a first case including a key operation unit, and a second case connected to said first case, comprising:
determination means for determining whether a terminal of the portable telephone is in await state for incoming and outgoing calls;
detection means for detecting a state that said first case and said second case overlap each other and a release of the state that said first case and said second case overlap each other;
time counting means for counting a preset setting time upon a detection by said detection means of the state that said first and second cases overlap each other; and
means for, when said determination means determines to be in the wait state and then said time counting means detects that the setting time has elapsed, invalidating key entries except at least an entry of personal identification codes in said key operation unit.

6. The portable telephone according to claim 5, wherein, in a foldable type terminal in which said second case is connected to said first case via a joining part in a freely openable and closable manner, said detection means detects an opened state of the first case and the second case as the release of the state that said first case and said second case overlap each other.

7. The portable telephone according to claim 5, wherein, in a rotary type terminal in which said second case is connected to said first case via the joining part so as to be rotated along a key operation face of said key operation unit, said detection means detects a state that said second case is rotated by a predetermined amount around a joining part relative to said first case, as the release of the state that said first and second cases overlap each other.

8. The portable telephone according to claim 5, wherein, in a slide storage type terminal in which said second case freely receives said first case by sliding said first case in a longitudinal direction, said detection means detects a state that said second case is slid by a predetermined amount relative to said first case as the release of the state that said first and second cases overlap each other.

9. A foldable type portable telephone having a first case including a key operation unit, and a second case connected to said first case in a freely openable and closable manner, wherein
when a preset setting time has elapsed since a detection of a closed state of said first and second cases while a terminal of the foldable type portable telephone is in a wait state for incoming and outgoing calls, key entries except at least an entry of personal identification codes for unlocking are invalidated in said key operation unit.

10. A foldable type portable telephone having a first case including a key operation unit, and a second case connected to said first case in a freely openable and closable manner, comprising:
determination means for determining whether a terminal of the foldable type portable telephone is in await state for incoming and outgoing calls;
detection means for detecting an opened state and a closed state of said first and second cases;
time counting means for counting a preset setting time upon a detection by said detection means of the closed state of the first and second cases; and
means for, when said determination means determines to be in the wait state and then said time counting means detects that the setting time has elapsed, invalidating key entries except at least an entry of personal identification codes in said key operation unit.

11. The foldable type portable telephone according to claim 10, wherein said means for invalidating key entries invalidates the key entries when setting information is preset to automatically inhibit the key entries in said key operation unit.

12. The foldable type portable telephone according to claim 10, wherein, when a, previously set predetermined operation is performed before the setting time elapses, said time counting means once clears the count of time and then restarts counting the setting time.

13. The foldable type portable telephone according to claim 10, further comprising:
means for setting the setting time in accordance with instruction information from outside.

14. A portable telephone having a first case including a key operation unit, and a second case connected to said first case, wherein
when a preset setting time has elapsed since a detection of a specified state of said first and second cases while a terminal of the portable telephone is in a wait state for incoming and outgoing calls, key entries except at least an entry of personal identification codes for unlocking are invalidated in said key operation unit.

15. The portable telephone according to claim 14, wherein said second case is a foldable type terminal connected to said first case via a joining part in a freely openable and closable manner.

16. The portable telephone according to claim 14, wherein said second case is a rotary type terminal connected to said first case via a joining part so as to be rotated along a key operation face of said key operation unit.

17. The portable telephone according to claim 14, wherein said second case is a slide storage type terminal that freely receives said first case by sliding the first case in a longitudinal direction.

18. A portable telephone having a first case including a key operation unit, and a second case connected to said first case, comprising:
determination means for determining whether a terminal of the portable telephone is in a wait state for incoming and outgoing calls;
detection means for detecting a specified state of said first and second cases;
time counting means for counting a preset setting time upon a detection by said detection means of the specified state of the first and second cases; and
means for, when said determination means determines to be in the wait state and then the time counting means detects that the setting time has elapsed, invalidating key entries except at least an entry of personal identification codes in said key operation unit.

19. The portable telephone according to claim 18, wherein said detection means detects either one of a state that said first and second cases overlap each other and a release of the state that said first and second cases overlap each other, as the specified state.

20. The portable telephone according to claim 19, wherein, in a foldable type terminal in which said second case is connected to said first case via a joining part in a freely openable and closable manner, said detection means detects an opened state of said first and second cases, as the release of the state that said first and second cases overlap each other.

21. The portable telephone according to claim 19, wherein, in a rotary type terminal in which said second case is connected to said first case via a joining part so as to be rotated along a key operation face of said key operation unit, said detection means detects a state that said second case is rotated by a predetermined amount around the joining part relative to said first case, as the release of the state that said first and second cases overlap each other.

22. The portable telephone according to claim 19, wherein, in a slide storage type terminal in which said second case freely receives said first case by sliding said first case in a longitudinal direction, said detection means detects a state that said second case is slid by a predetermined amount relative to said first case, as the release of the state that said first and second cases overlap each other.

23. The portable telephone according to claim 18, wherein said means for invalidating key entries invalidates the key entries when setting information is preset to automatically inhibit the key entries in said key operation unit.

24. The portable telephone according to claim 18, wherein, when a previously set predetermined operation is performed before the setting time elapses, said time counting means once clears the count of time and then restarts counting the setting time.

25. The portable telephone according to claim 18, further comprising:
means for setting the setting time in accordance with instruction information from outside.

26. The portable telephone according to claim 18, wherein, when the previously set predetermined operation is performed before the setting time elapses, said time counting means once clears the detection of elapse of the setting time and then restarts detecting elapse of the setting time.

27. The portable telephone according to claim 24, wherein, when the predetermined operation is performed through a side key, said time counting means once clears the detection of elapse of the setting time and then restarts detecting elapse of the setting time.

28. A foldable type portable telephone having a first case including a key operation unit, and a second case connected to said first case in a freely openable and closable manner, wherein
when a preset setting time has elapsed since a detection of a specified state of said first and second cases while a terminal of the foldable type portable telephone is in a wait state for incoming and outgoing calls, key entries except at least an entry of personal identification codes for unlocking are invalidated in said key operation unit.

29. A foldable type portable telephone having a first case including a key operation unit, and a second case connected to said first case in a freely openable and closable manner, comprising:
determination means for determining whether a terminal of the foldable type portable telephone is in await state for incoming and outgoing calls;
detection means for detecting an opened state and a closed state of said first and second cases;
time counting means for counting a preset setting time upon a detection by said detection means of a specified state of said first and second cases; and
means for, when said determination means determines to be in the wait state and then said time counting means detects that the setting time has elapsed, invalidating key entries except at least an entry of personal identification codes in said key operation unit.

30. The foldable type portable telephone according to claim 29, wherein said means for invalidate key entries invalidates the key entries when setting information is preset to automatically inhibit the key entries in said key operation unit.

31. The foldable type portable telephone according to claim 29, wherein, a previously set predetermined operation is performed before the setting time elapses, said time counting means once clears the count of time and then restarts counting the setting time.

32. The foldable type portable telephone according to claim 29, further comprising:
means for setting the setting time in accordance with instruction information from outside.

33. The foldable type portable telephone according to claim 28, wherein, when the previously set predetermined operation is performed before the setting time elapses, said time counting means once clears the detection of elapse of the setting time and then restarts detecting elapse of the setting time.

34. The foldable type portable telephone according to claim 33, wherein, when the predetermined operation is performed through. a side key, said time counting means once clears the detection of elapse of the setting time and then restarts detecting elapse of the setting time.

35. The foldable type portable telephone according to claim 28, wherein the specified state is at least either one of the opened state and the closed state of said first and second cases.

36. An auto dial lock method for a portable telephone having a first case including a key operation unit, and a second case connected to said first case, the method comprising:
a first step of determining whether a terminal of the portable telephone is in a wait state for incoming and outgoing calls;
a second step of detecting a state that said first and second cases overlap each other and a release of the state that said first and second cases overlap each other;
a third step of determining whether a preset setting time has elapsed since the detection of the state that said first and second cases overlap each other; and
a fourth step of, when determined to be in the wait state and then detected that the setting time has elapsed, invalidating key entries except at least an entry of personal identification codes in said key operation unit.

37. The auto dial lock method according to claim 36, wherein, in a foldable type terminal in which said second case is connected to said first case via a joining part in a freely openable and closable manner, said second step includes detecting an opened state of said first and second cases, as the release of the state that said first and second cases overlap each other.

38. The auto dial lock method according to claim 36, wherein, in a rotary type terminal in which said second case is connected to said first case via a joining part so as to be rotated along a key operation face of said key operation unit, said second step includes detecting a state that said second case is rotated by a predetermined amount around a joining part relative to said first case, as the release of the state that said first and second cases overlap each other.

39. The auto dial lock method according to claim 36, wherein, in a slide storage type terminal in which said second case freely receives said first case by sliding said first case in a longitudinal direction, said second step includes detecting a state that said second case is slid by a predetermined amount relative to said first case, as the release of the state that said first and second cases overlap each other.

40. The auto dial lock method according to claim 36, wherein said fourth step includes invalidating the key entries when setting information is preset to automatically inhibit the key entries in said key operation unit.

41. The auto dial lock method according to claim 36, wherein, when a previously set predetermined operation is performed before the setting time elapses, the detection of elapse of the setting time is once cleared and then restarted.

42. An auto dial lock method for a portable telephone having a first case including a key operation unit, and a second case connected to said first case, the method comprising:
a first step of determining whether a terminal of the portable telephone is in a wait state for incoming and outgoing calls;
a second step of detecting a specified state of said first and second cases;
a third step of determining whether a preset setting time has elapsed since the detection of the specified state; and
a fourth step of, when determined to be in the wait state and then detected that the setting time has elapsed, invalidating key entries except at least an entry of personal identification codes in said key operation unit.

43. The auto dial lock method according to claim 42, wherein said second step includes detecting either one of a state that said first and second cases overlap each other and a release of the state that said first and second cases overlap each other, as the specified state.

44. The auto dial lock method according to claim 42 in a foldable type terminal in which said second case is connected to said first case via a joining part in a freely openable and closable manner, the second step includes detecting an opened state of said first said second cases, as the release of the state that said first and second cases overlap each other.

45. The auto dial lock method according to claim 42, wherein, in a rotary type terminal in which said second case is connected to said first case via a joining part so as to be rotated along a key operation face of said key operation unit said second step includes detecting a state that said second case is rotated by a predetermined amount around a joining part relative to said first case, as the release of the state that said first and second cases overlap each other.

46. The auto dial lock method according to claim 42, wherein, in a slide storage type terminal in which said second case freely receives said first case by sliding said first case in a longitudinal direction, said second step includes detecting a state that said second case is slid by a predetermined amount relative to said first case, as the release of the state that said first and second cases overlap each other.

47. The auto dial lock method according to claim 42, wherein said fourth step includes invalidating the key entries when setting information is preset to automatically inhibit the key entries in said key operation unit.

48. The auto dial lock method according to claim 42, wherein, when a previously set predetermined operation is performed before the setting time elapses, the detection of elapse of the setting time is once cleared and then restarted.

49. The auto dial lock method according to claim 48, wherein, when the predetermined operation is performed through a side key, the detection of elapse of the setting time is once cleared and then restarted.

50. An auto dial lock method for a foldable type potable telephone having a first case including a key operation unit, and a second case connected to said first case in a freely openable and closable manner, the method comprising:
a step of determining whether a terminal of the foldable type portable telephone is in await state for incoming and outgoing calls;
a step of detecting an opened state and a closed state of said first and second cases;
a step of determining whether a preset setting time has elapsed since the detection of the closed state of said first and second cases; and
a step of, when determined to be in the wait state and then detected that the setting time has elapsed, invalidating key entries except at least an entry of personal identification codes in said key operation unit.

51. The auto dial lock method according to claim 50, wherein said step of invalidating key entries includes invalidating the key entries when setting information is preset to automatically inhibit said key entries in said key operation unit.

52. The auto dial lock method according to claim 50, wherein, when a previously set predetermined operation is performed before the setting time elapses, the detection of elapse of the setting time is once cleared and then restarted.

53. An auto dial lock method for a foldable type potable telephone having a first case including a key operation unit, and a second case connected to said first case in a freely openable and closable manner, the method comprising:
a step of determining whether a terminal of the foldable type portable telephone is in await state for incoming and outgoing calls;
a step of detecting a specified state of said first and second cases;
a step of determining whether a preset setting time has elapsed since the detection of the specified state; and
a step of, when determined to be in the wait state and then detected that the setting time has elapsed, invalidating key entries except at least an entry of personal identification codes in said key operation unit.

54. The auto dial lock method according to claim 53, wherein said step of invalidating key entries includes invalidating the key entries when setting information is preset to automatically inhibit the key entries in said key operation unit.

55. The auto dial lock method according to claim 53, wherein, when a previously set predetermined operation is performed before the setting time elapses, the detection of elapse of the setting time is once cleared and then restarted.

56. The auto dial lock method according to claim 55, wherein, when the predetermined operation is performed through a side key, the detection of elapse of the setting time is once cleared and then restarted.

57. The auto dial lock method according to claim 53, wherein the specified state is at least either one of the opened state and the closed state of said first and second cases.

58. A program of an auto dial lock method for a portable telephone having a first case including a key operation unit, and a second case connected to said first case, wherein the program makes a computer execute the steps of:
determining whether a terminal of the portable telephone is in a wait state for incoming and outgoing calls;
detecting a state that said first and second cases overlap each other and a release of the state that said first and second cases overlap each other;
determining whether a preset setting time has elapsed since the detection of the state that said first and second cases overlap each other; and
when determined to be in the wait state and then detected that the setting time has elapsed, invalidating key entries except at least an entry of personal identification codes in the key operation unit.

59. A program of an auto dial lock method for a foldable type portable telephone having a first case including a key operation unit, and a second case connected to said first case, wherein the program makes a computer execute the steps of:
determining whether a terminal of the portable telephone is in a wait state for incoming and outgoing calls;
detecting a specified state of said first and second cases;
determining whether a preset setting time has elapsed since the detection of the specified state; and
when determined to be in the wait state and then detected that the setting time has elapsed, invalidating key entries except at least an entry of personal identification codes in said key operation unit.

60. A program of an auto dial lock method for a foldable type portable telephone having a first case including a key operation unit, and a second case connected to said first case in a freely openable and closable manner, wherein the program makes a computer execute the steps of:
determining whether a terminal of the foldable type portable telephone is in a wait state for incoming and outgoing calls;
detecting an opened state and a closed state of said first and second cases;
determining whether a preset setting time has elapsed since the detection of the closed state of said first and second cases; and
when determined to be in the wait state and then detected that the setting time has elapsed, invalidating key entries except at least an entry of personal identification codes in the key operation unit.

61. A program of an auto dial lock method for a foldable type portable telephone having a first case including a key operation unit, and a second case connected to said first case in a freely openable and closable manner, wherein the program makes a computer execute the steps of:
determining whether a terminal of the foldable type portable telephone is in a wait state for incoming and outgoing calls;
detecting a specified state of said first and second cases;
determining whether a preset setting time has elapsed since the detection of the specified state of said first and second cases; and
when determined to be in the wait state and then detected that the setting time has elapsed, invalidating key entries except at least an entry of personal identification codes in said key operation unit.
